(19) United States
(12) Patent Application Publication
(10) Pub. No.: US 2017/0269961 A1
(43) Pub. Date: Sep. 21, 2017

(54) APPLICATION PROGRAM SWITCHING METHOD AND APPARATUS, AND ELECTRONIC TERMINAL

(71) Applicant: Huawei Technologies Co., Ltd., Shenzhen, Guangdong (CN)

(72) Inventors: Shunan Fan, Beijing (CN); Wenmei Gao, Beijing (CN); Yahui Wang, Beijing (CN); Hao Jing, Shenzhen (CN)

(21) Appl. No.: 15/505,034

(22) PCT Filed: Aug. 20, 2014
(86) PCT No.: PCT/CN2014/084833

§ 371 Date: Feb. 17, 2017

(51) Int. Cl. G06F 9/48; G06F 9/54

(52) U.S. Cl. CPC G06F 9/48; G06F 9/543

(57) ABSTRACT

The present invention discloses an application program switching method, relates to the data processing field, and is used to implement fast switching between application programs. According to a technical solution provided in the present invention, in response to a switching request, an application program association relationship is searched for a second application program that satisfies a requirement of a user, and the second application program is directly started, so that the user can start the second application program by sending the switching request only once. Embodiments of the present invention may be applied to an application program switching scenario.

### CROSS REFERENCE TO RELATED APPLICATIONS

The present application claims priority under 35 U.S.C. §365 to International Patent Application No. PCT/CN2014/084833 filed Aug. 20, 2014, which is incorporated herein by reference into the present disclosure as if fully set forth herein.

### TECHNICAL FIELD

The present invention relates to the data processing field, and in particular, to an application program switching method and apparatus, and an electronic terminal.

### BACKGROUND

Currently, a user may install an application program on various local electronic devices such as a mobile phone, a tablet computer, and a television. All these applications run independently, and are all managed by using an operating system to perform an operation such as opening or closing. When the user wants to switch from an application program to another application program, the user needs to exit from a first application program, return to a home screen of the operating system, and then select, from multiple installed application programs, a second application program that the user wants to open. Such an operation is extremely cumbersome and complex, and is inconvenient for the user to operate.

### SUMMARY

Embodiments of the present invention provide an application program switching method and apparatus, and an electronic terminal, so as to simplify, to some extent, an operation procedure performed when a user switches a program, so that a switching operation becomes more convenient.

To achieve the foregoing objective, the following technical solutions are adopted in the embodiments of the present invention:

According to a first aspect, an embodiment of the present invention provides an application program switching method, including:

obtaining a switching request, where the switching request is used to request to switch from a first application program to a second application program; and

determining the second application program from an application program association relationship according to the obtained switching request, and starting the second application program.

With reference to the first aspect, in a first possible implementation manner of the first aspect, before the obtaining a switching request, the method further includes:

obtaining type information of a to-be-added application program;

determining, from the existing application program association relationship, an application program association relationship corresponding to the type information; and

if there is the application program association relationship corresponding to the type information, adding the to-be-added application program to the application program association relationship corresponding to the type information.

With reference to the first possible implementation manner of the first aspect, in a second possible implementation manner, after the adding the to-be-added application program to the application program association relationship corresponding to the type information, the method further includes:

setting a switching sequence between an application program in the application program association relationship corresponding to the type information and the to-be-added application program.

With reference to the first aspect or the first possible implementation manner of the first aspect, in a third possible implementation manner, after the determining, from the existing application program association relationship, an application program association relationship corresponding to the type information, the method further includes:

if there is no application program association relationship corresponding to the type information, establishing a new application program association relationship that includes only the to-be-added application program, and setting type information of the new application program association relationship as the type information of the to-be-added application program.

With reference to the third possible implementation manner of the first aspect, in a fourth possible implementation manner, before the obtaining a switching request, the method further includes:

obtaining an associated program corresponding to a third application program, where the third application program is an application program that has been added to an application program association relationship; and

adding the associated program to the application program association relationship to which the third application program belongs, and setting a switching sequence between the associated program and another application program in an application program association relationship to which the first application program belongs.

With reference to the fourth possible implementation manner of the first aspect, in a fifth possible implementation manner, when a switching manner specified in the switching request is sequential switching, the determining the second application program from an application program association relationship according to the obtained switching request includes:

obtaining the another application program that belongs to the same application program association relationship as the first application program and a corresponding switching sequence; and

determining, according to a switching direction and an offset that are indicated in the switching request and the switching sequence of the another application program that belongs to the same application program association relationship as the first application program, the second application program from the another application program that belongs to the same application program association relationship as the first application program.

With reference to the fourth possible implementation manner of the first aspect, in a sixth possible implementation manner, when a switching manner specified in the switching request is specified switching, and the switching request carries identification information of the second application program, the determining the second application program from an application program association relationship according to the obtained switching request includes:

determining, according to the identification information of the second application program, the second application program from the another application program that belongs to the same application program association relationship as the first application program.

With reference to the fourth possible implementation manner of the first aspect, in a seventh possible implementation manner, when a switching manner specified in the switching request is specified switching, and the switching request carries association relationship identification information and identification information of the second application program, the determining the second application program from an application program association relationship according to the obtained switching request includes:

determining, according to the identification information of the second application program, the second application program from an application program that belongs to an application program association relationship list corresponding to the association relationship identification information.

According to a second aspect, the present invention further provides an application program switching apparatus, including:

a first obtaining unit, configured to obtain a switching request, where the switching request is used to request to switch from a first application program to a second application program;

a first determining unit, configured to determine the second application program from an application program association relationship according to the obtained switching request; and

a switching unit, configured to start the second application program.

With reference to the second aspect, in a first possible implementation manner of the second aspect, the apparatus further includes:

a second obtaining unit, configured to obtain type information of a to-be-added application program;

a second determining unit, configured to determine, from the existing application program association relationship, an application program association relationship corresponding to the type information; and

a first setting unit, configured to: if there is the application program association relationship corresponding to the type information, add the to-be-added application program to the application program association relationship corresponding to the type information.

With reference to the first possible implementation manner of the second aspect, in a second possible implementation manner, the first setting unit is further configured to set a switching sequence between an application program in the application program association relationship corresponding to the type information and the to-be-added application program.

With reference to the second aspect or the first possible implementation manner of the second aspect, in a third possible implementation manner, the first setting unit is further configured to: if there is no application program association relationship corresponding to the type information, establish a new application program association relationship that includes only the to-be-added application program, and set type information of the new application program association relationship as the type information of the to-be-added application program.

With reference to the third possible implementation manner of the second aspect, in a fourth possible implementation manner, the apparatus further includes:

a third obtaining unit, configured to obtain an associated program corresponding to a third application program, where the third application program is an application program that has been added to an application program association relationship; and

a second setting unit, configured to: add the associated program to the application program association relationship to which the third application program belongs, and set a switching sequence between the associated program and another application program in an application program association relationship to which the first application program belongs.

With reference to the fourth possible implementation manner of the second aspect, in a fifth possible implementation manner, the first determining unit includes:

an obtaining module, configured to: when a switching manner specified in the switching request is sequential switching, obtain the another application program that belongs to the same application program association relationship as the first application program and a corresponding switching sequence; and

a first determining module, configured to: determine, according to a switching direction and an offset that are indicated in the switching request and the switching sequence of the another application program that belongs to the same application program association relationship as the first application program, the second application program from the another application program that belongs to the same application program association relationship as the first application program.

With reference to the fourth possible implementation manner of the second aspect, in a sixth possible implementation manner, the first determining unit includes:

a second determining module, configured to: when a switching manner specified in the switching request is specified switching, and the switching request carries identification information of the second application program, determine, according to the identification information of the second application program, the second application program from the another application program that belongs to the same application program association relationship as the first application program.

With reference to the fourth possible implementation manner of the second aspect, in a seventh possible implementation manner, the first determining unit includes:

a third determining module, configured to: when a switching manner specified in the switching request is specified switching, and the switching request carries association relationship identification information and identification information of the second application program, determine, according to the identification information of the second application program, the second application program from an application program that belongs to an application program association relationship list corresponding to the association relationship identification information.

According to a third aspect, an embodiment of the present invention further provides an electronic terminal, including a processor, a memory, and an input/output interface, where the memory stores an application program, and the processor invokes the application program stored in the memory, and controls the input/output interface;

the input/output interface is configured to obtain a switching request, where the switching request is used to request to switch from a first application program to a second application program;

the processor is configured to: determine the second application program from an application program association relationship according to the obtained switching request, and start the second application program; and

the memory is further configured to store the application program association relationship.

With reference to the third aspect, in a first possible implementation manner of the third aspect, before the step of obtaining a switching request is executed, the processor is further configured to: obtain type information of a to-be-added application program; determine, from the existing application program association relationship, an application program association relationship corresponding to the type information; and if there is the application program association relationship corresponding to the type information, add the to-be-added application program to the application program association relationship corresponding to the type information.

With reference to the first possible implementation manner of the third aspect, in a second possible implementation manner, after executing the step of adding the to-be-added application program to the application program association relationship corresponding to the type information, the processor is further configured to set a switching sequence between an application program in the application program association relationship corresponding to the type information and the to-be-added application program.

With reference to the third aspect or the first possible implementation manner of the third aspect, in a third possible implementation manner, after executing the step of determining, from the existing application program association relationship, an application program association relationship corresponding to the type information, the processor is further configured to: if there is no application program association relationship corresponding to the type information, establish a new application program association relationship that includes only the to-be-added application program, and set type information of the new application program association relationship as the type information of the to-be-added application program.

With reference to the third possible implementation manner of the third aspect, in a fourth possible implementation manner, before the step of obtaining a switching request is executed, the processor is further configured to: obtain an associated program corresponding to a third application program, where the third application program is an application program that has been added to an application program association relationship; add the associated program to the application program association relationship to which the third application program belongs; and set a switching sequence between the associated program and another application program in an application program association relationship to which the first application program belongs.

With reference to the fourth possible implementation manner of the third aspect, in a fifth possible implementation manner, when executing the step of determining the second application program from an application program association relationship according to the obtained switching request, the processor is specifically configured to: when a switching manner specified in the switching request is sequential switching, obtain the another application program that belongs to the same application program association relationship as the first application program and a corresponding switching sequence; and determine, according to a switching direction and an offset that are indicated in the switching request and the switching sequence of the another application program that belongs to the same application program association relationship as the first application program, the second application program from the another application program that belongs to the same application program association relationship as the first application program.

With reference to the fourth possible implementation manner of the third aspect, in a sixth possible implementation manner, when executing the step of determining the second application program from an application program association relationship according to the obtained switching request, the processor is specifically configured to: when a switching manner specified in the switching request is specified switching, and the switching request carries identification information of the second application program, determine, according to the identification information of the second application program, the second application program from the another application program that belongs to the same application program association relationship as the first application program.

With reference to the fourth possible implementation manner of the third aspect, in a seventh possible implementation manner, when executing the step of determining the second application program from an application program association relationship according to the obtained switching request, the processor is specifically configured to: when a switching manner specified in the switching request is specified switching, and the switching request carries association relationship identification information and identification information of the second application program, determine, according to the identification information of the second application program, the second application program from an application program that belongs to an application program association relationship list corresponding to the association relationship identification information.

According to the application program switching method and apparatus, and the electronic terminal that are provided in the embodiments of the present invention, in response to a switching request, an application program association relationship is searched for a second application program that satisfies a requirement of a user, and the second application program is directly started, so that the user can start the second application program by sending the switching request only once. According to an existing technical solution in the prior art, the user needs to close a currently used program, return to a homepage of an operating system, then search multiple application programs for a new application program, and select the new application program to start. In comparison, according to a technical solution in the present invention, the user only needs to send a switching request, and a terminal automatically completes a remaining procedure, which is faster and more convenient, and brings better experience to the user.

### BRIEF DESCRIPTION OF THE DRAWINGS

To describe the technical solutions in the embodiments of the present invention or in the prior art more clearly, the following briefly describes the accompanying drawings required for describing the embodiments or the prior art. Apparently, the accompanying drawings in the following description show merely some embodiments of the present invention, and a person of ordinary skill in the art may still derive other drawings from these accompanying drawings without creative efforts.

FIG. 1 is a flowchart of an application program switching method according to an embodiment of the present invention;

FIG. 2 is a schematic diagram of a relationship between an application program and an associated program according to an embodiment of the present invention;

FIG. 3 is a schematic diagram of another relationship between an application program and an associated program according to an embodiment of the present invention;

FIG. 4 is a flowchart of a method for generating an application program association relationship according to an embodiment of the present invention;

FIG. 5 is a flowchart of another method for generating an application program association relationship according to an embodiment of the present invention;

FIG. 6 is a structural block diagram of an application program switching apparatus according to an embodiment of the present invention;

FIG. 7 is a structural block diagram of another application program switching apparatus according to an embodiment of the present invention;

FIG. 8 is a structural block diagram of another application program switching apparatus according to an embodiment of the present invention;

FIG. 9 is a structural block diagram of another application program switching apparatus according to an embodiment of the present invention;

FIG. 10 is a structural block diagram of another application program switching apparatus according to an embodiment of the present invention;

FIG. 11 is a structural block diagram of another application program switching apparatus according to an embodiment of the present invention; and

FIG. 12 is a structural block diagram of an electronic terminal according to an embodiment of the present invention.

### DETAILED DESCRIPTION

The following clearly and completely describes the technical solutions in the embodiments of the present invention with reference to the accompanying drawings in the embodiments of the present invention. Apparently, the described embodiments are merely some but not all of the embodiments of the present invention. All other embodiments obtained by a person of ordinary skill in the art based on the embodiments of the present invention without creative efforts shall fall within the protection scope of the present invention.

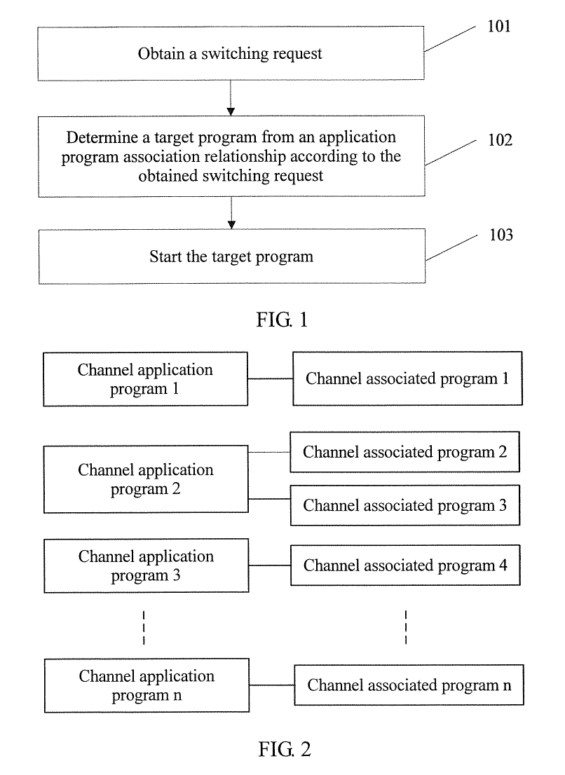

The present invention provides an application program switching method to implement fast switching between two application programs and bring better experience to a user. The method may be applied to an operating system in a terminal such as a tablet computer, a smartphone, a smart television, a wearable device, or a computer, or may further be implemented in a particular application program or service of an operating system. A method procedure is shown in FIG. 1, and includes the following steps.

101. Obtain a switching request.

The switching request is used to request to switch from a first application program to a second application program. A specific switching request may be a sequential switching request or a request for specified switching. The sequential switching request requests switching between two adjacent application programs, and the request for specified switching requests to directly switch to a particular application program.

To facilitate switching performed by a user, in this embodiment of the present invention, a terminal may provide, for the user, a floating leftwards/rightwards key that indicates opening an application program in a backwards or forwards sequence, and may further provide, for the user, an application program identifier that includes a number, a letter, a character, or the like. In this case, the user may tap the floating key or enter the application program identifier to send a switching request. These trigger operations may be implemented by using a remote control, a gesture action, or the like. The application program identifier may be provided for the user in a manner of an index, so that the user performs selection or performs an entering operation.

102. Determine a second application program from an application program association relationship according to the obtained switching request.

In this embodiment of the present invention, the application program association relationship may be used to limit a switching sequence between multiple application programs or between an application program and an associated program. Generally, an application program and an associated program that are in a same application program association relationship have same type information, for example, video software, reading software, and game software. Alternatively, an application program and an associated program that are in a same application program association relationship have a type that complies with a human habit relationship; for example, stock software is sequentially associated with news software according to a use habit of the user.

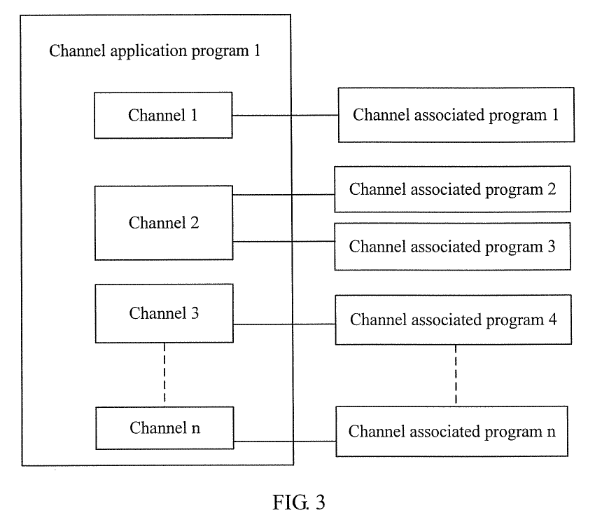

The associated program described herein is an application program related to an application program, and a corresponding relationship between the associated program and the particular application program may be that the two application programs belong to a same channel or a same application provider. For example, a satellite television Chinese channel is a channel, and a forum application of the satellite television Chinese channel is an associated application of a video application of the satellite television Chinese channel. For details, refer to examples shown in FIG. 2 and FIG. 3. A channel application program and a channel associated program are used as examples in both FIG. 2 and FIG. 3. FIG. 2 shows a relationship between an application program and an associated program in a case in which in a terminal, multiple independent channel application programs are respectively corresponding to different channel associated programs. FIG. 3 shows a relationship between an application program and an associated program in a case in which an independent channel application program includes multiple channels, and each channel is further associated with one or more channel associated programs. For another example, a living channel, a sports channel, a news channel, and a movie channel of a satellite television serve as application programs, and these channels each may also be an associated program of each other. These channels are associated to establish an application program association relationship, so as to facilitate switching performed by the user.

The application program association relationship may be stored in the terminal in a manner such as a list. For ease of management and searching, an application program and an associated program that belong to a same application program association relationship may be put at consecutive storage locations, for example, put in a same folder or a same directory. In addition, an identifier is set for each application program association relationship.

103. Start the second application program.

In this embodiment, while the second application program is started, the first application program may be exited from, or may be hidden in a background to maintain a running state.

According to the application program switching method provided in this embodiment of the present invention, in response to a switching request, an application program association relationship is searched for a second application program that satisfies a requirement of a user, and the second application program is directly started, so that the user can start the second application program by sending the switching request only once. According to an existing technical solution in the prior art, the user needs to close a currently used program, return to a homepage of an operating system, then search multiple application programs for a new application program, and select the new application program to start. In comparison, according to a technical solution in the present invention, the user only needs to send a switching request, and a terminal automatically completes a remaining procedure, which is faster and more convenient, and brings better experience to the user.

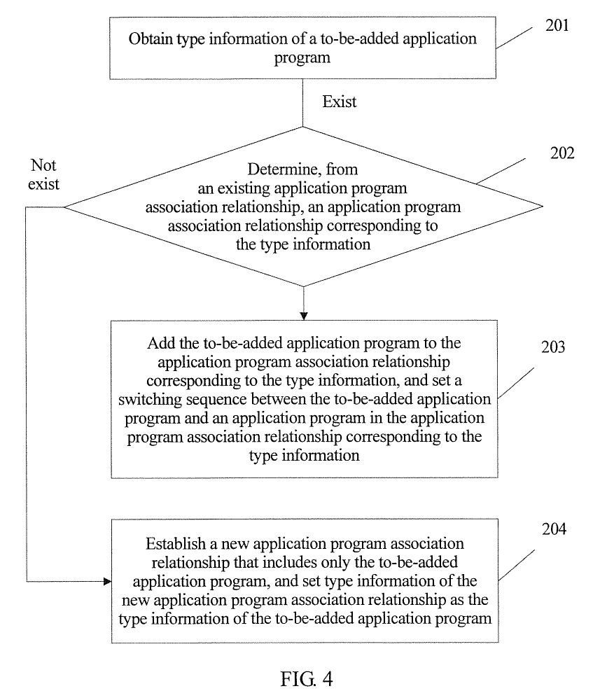

For the application program association relationship mentioned in the foregoing implementation manner, this embodiment of the present invention further provides a method for generating an application program association relationship. The method may be executed before step 101. As shown in FIG. 4, the method may include the following steps.

201. Obtain type information of a to-be-added application program.

The “to-be-added” described herein means waiting to be added to the foregoing application program association relationship. Therefore, the to-be-added application program means an application program that needs to be added to the foregoing application program association relationship. The to-be-added application program may be an application program that has been installed in a terminal but has not been added to any application program association relationship yet, or may be a new application program installed in a terminal.

Herein, it should be further noted that the foregoing type information is identification information used to distinguish between application programs, and may be implemented by adding a new parameter to an original metadata type of an application program. For example, the new parameter may be an identifier such as a video type, a game type, a channel 1 of a video type, or a channel 2 of a video type. These types may be set by a developer when developing the application program, or may be defined and set by a user according to a preference of the user.

For example, the obtaining type information of a to-be-added application program may be operated and completed by a browser, or may be operated and completed by an operating system.

202. Determine, from the existing application program association relationship, an application program association relationship corresponding to the type information. If there is the application program association relationship corresponding to the type information, step 203 is executed; or if there is no application program association relationship corresponding to the type information, step 204 is executed.

203. Add the to-be-added application program to the application program association relationship corresponding to the type information, and set a switching sequence between an application program in the application program association relationship corresponding to the type information and the to-be-added application program.

If the type information of the to-be-added application program is the same as type information of an existing application program, the to-be-added application program is added to an association relationship of the existing application program. For example, if the existing program has a video type application program, a to-be-added video type application program is automatically added to an association relationship of the existing video type application program. In addition, a switching sequence between the to-be-added application program and another application program may be randomly generated, or the to-be-added application program may be added closely after an existing switching sequence, or a switching sequence may be set by referring to a principle that a frequently-used application is first switched to and according to frequency of using each application program by the user.

204. Establish a new application program association relationship that includes only the to-be-added application program, and set type information of the new application program association relationship as the type information of the to-be-added application program.

If the type information of the to-be-added application program is different from the type information of the existing program, the new association relationship that includes the to-be-added application program is established, and the type information of the to-be-added application program is set as the type information of the new association relationship. For example, if the type information of the to-be-added application program is a game, and the existing application program does not have type information of a game, a new association relationship that includes the to-be-added application program and whose type information is a game is established.

In this implementation manner, a switching sequence between any application program and an existing application program may be established according to type information of any application program, so that it can be ensured that any application program in a terminal can be switched to when a user performs switching.

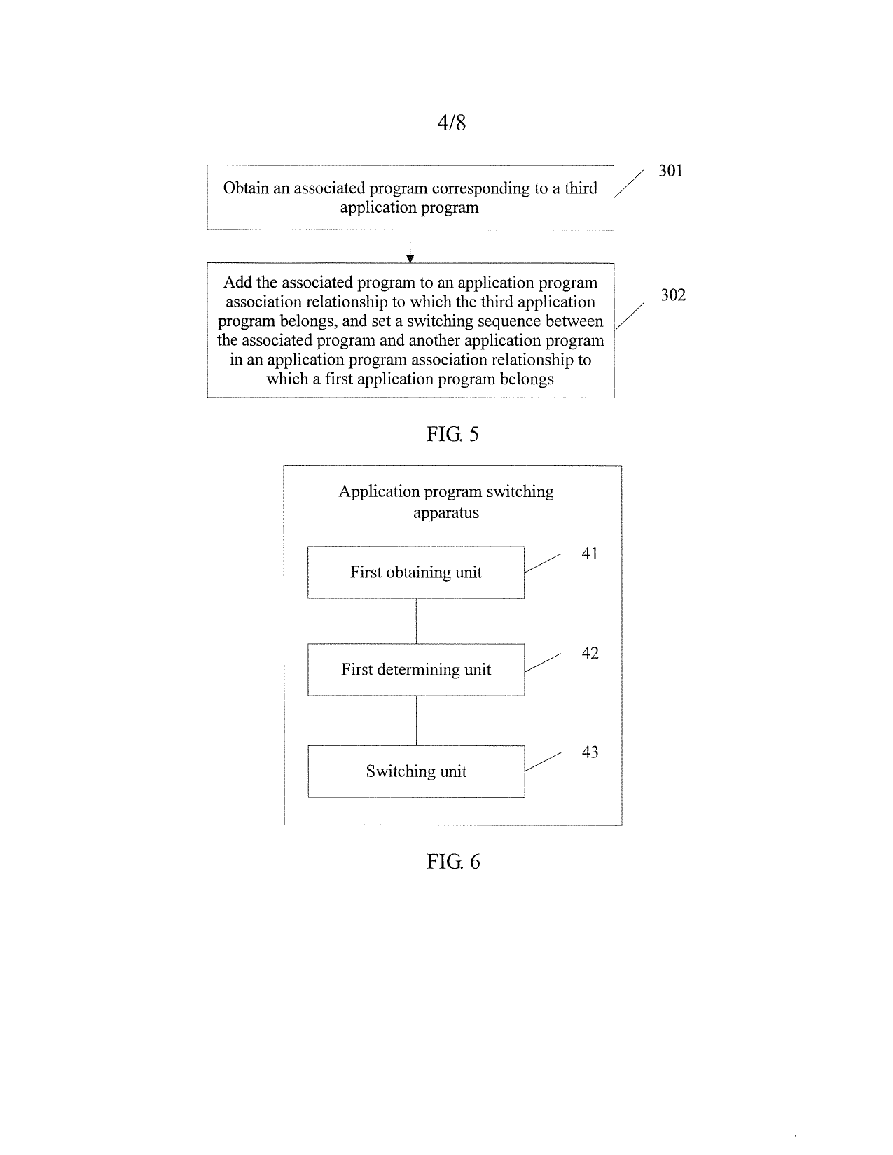

This embodiment of the present invention further provides a method for generating an application program association relationship. The method is used to implement the foregoing described special manner of adding an associated program, and may be executed before step 101. As shown in FIG. 5, the method may include the following steps.

301. Obtain an associated program corresponding to a third application program.

In this embodiment of the present invention, the third application program is an application program that has been added to an application program association relationship, that is, the third application program belongs to an application program association relationship. However, in this embodiment, the third application program is not required to belong to a particular application program association relationship. Therefore, the third application program may include the first application program and the second application program in the foregoing.

For a correspondence between an application program and an associated program, refer to related descriptions in step 102 and content shown in FIG. 2 and FIG. 3.

302. Add the associated program to an application program association relationship to which the third application program belongs, and set a switching sequence between the associated program and another application program in an application program association relationship to which the first application program belongs.

There is no difference between determining of a switching sequence and the foregoing described determining of an application program.

In addition, it should be noted that an application program association relationship of an associated program may be independently established by using steps 201 to 204.

In this implementation manner, a switching sequence between any application program and an existing application program may be established according to type information of the any application program, and application programs that have a specific association relationship may also be set in a same application program association relationship, so as to further facilitate searching and switching performed by a user.

Herein, this embodiment of the present invention further provides different responding methods that are based on different switching manners used by the user. Specifically, three different cases of two types of switching manners (sequential switching and specified switching) are involved, and are specifically as follows.

Use of sequential switching may be understood as that the user taps a “forwards” or “backwards” function key. Use of specified switching may be understood as that the user directly enters an identifier of the second application program, for example, a number or a character; or the user may start an electronic program menu, and select the second application program from the menu.

Case 1: When the switching manner specified in the switching request is sequential switching, the another application program that belongs to the same application program association relationship as the first application program and a corresponding switching sequence are obtained. The second application program is determined, according to a switching direction and an offset that are indicated in the switching request and the switching sequence of the another application program that belongs to the same application program association relationship as the first application program, from the another application program that belongs to the same application program association relationship as the first application program.

The switching direction indicated in the switching instruction generally includes forwards or backwards. The offset is generally one application program, or certainly may be more application programs.

Case 2: When the switching manner is specified switching, and the switching request carries identification information of the second application program, the second application program is determined, according to the identification information of the second application program, from the another application program that belongs to the same application program association relationship as the first application program.

The identification information of the second application program may be a name of the second application program, or a sequence number of the second application program in the application program association relationship.

Case 3: When the switching manner is specified switching, and the switching request carries association relationship identification information and identification information of the second application program, the second application program is determined, according to the identification information of the second application program, from an application program that belongs to an application program association relationship list corresponding to the association relationship identification information.

In this implementation manner, multiple switching manners are provided for a user. Therefore, the user can better select a to-be-used switching manner according to a requirement of the user, in order that a second application program is fastest selected.

In the embodiment described above, switching between application programs, generation of an application program association relationship, listening of a switching request manner of a user, and execution of a switching operation may be performed by a browser, or may be performed by an operating system.

An embodiment of the present invention further provides an application program switching apparatus that may be configured to implement the method procedures in FIG. 1 to FIG. 5. Composition of the apparatus is shown in FIG. 6, and the apparatus includes:

a first obtaining unit 41, configured to obtain a switching request, where the switching request is used to request to switch from a first application program to a second application program;

a first determining unit 42, configured to determine the second application program from an application program association relationship according to the obtained switching request, where the application program association relationship is used to limit a switching sequence between multiple application programs that have same type information; and

a switching unit 43, configured to start the second application program.

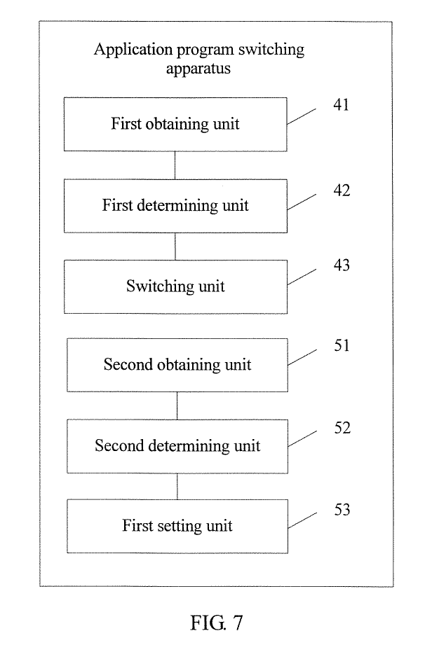

Optionally, as shown in FIG. 7, the apparatus further includes:

a second obtaining unit 51, configured to obtain type information of a to-be-added application program;

a second determining unit 52, configured to determine, from the existing application program association relationship, an application program association relationship corresponding to the type information; and

a first setting unit 53, configured to: if there is the application program association relationship corresponding to the type information, add the to-be-added application program to the application program association relationship corresponding to the type information.

Optionally, the first setting unit 53 is further configured to set a switching sequence between an application program in the application program association relationship corresponding to the type information and the to-be-added application program.

Optionally, the first setting unit 53 is further configured to: if there is no application program association relationship corresponding to the type information, establish a new application program association relationship that includes only the to-be-added application program, and set type information of the new application program association relationship as the type information of the to-be-added application program.

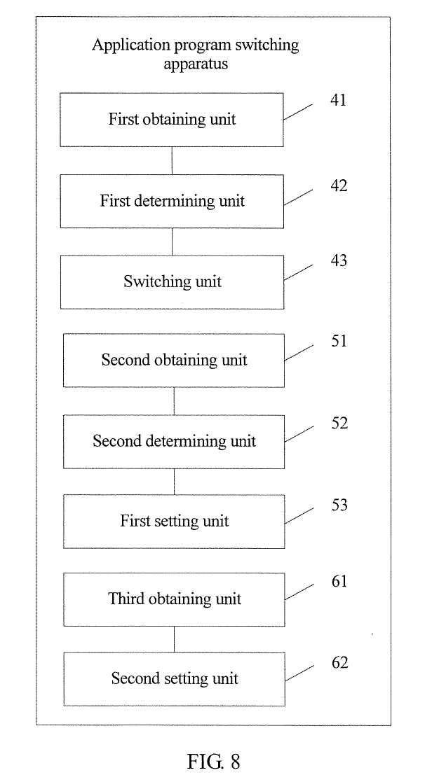

Optionally, as shown in FIG. 8, the apparatus further includes:

a third obtaining unit 61, configured to obtain an associated program corresponding to a third application program, where the third application program is an application program that has been added to an application program association relationship; and

a second setting unit 62, configured to: add the associated program to the application program association relationship to which the third application program belongs, and set a switching sequence between the associated program and another application program in an application program association relationship to which the first application program belongs.

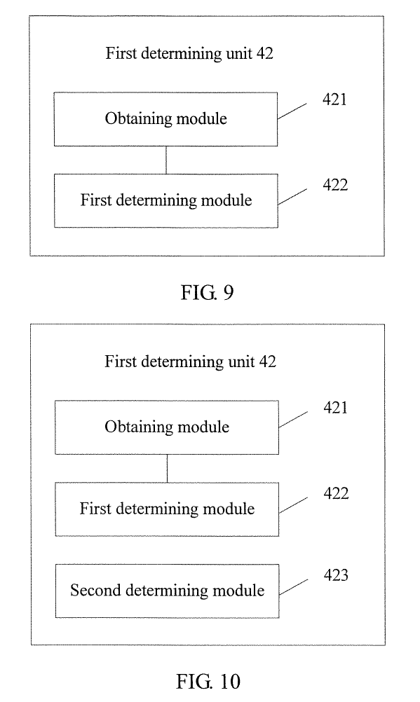

Optionally, as shown in FIG. 9, the first determining unit 42 further includes:

an obtaining module 421, configured to: when the switching manner is sequential switching, obtain the another application program that belongs to the same application program association relationship as the first application program and a corresponding switching sequence; and

a first determining module 422, configured to: determine, according to a switching direction and an offset that are indicated in the switching request and the switching sequence of the another application program that belongs to the same application program association relationship as the first application program, the second application program from the another application program that belongs to the same application program association relationship as the first application program.

Optionally, as shown in FIG. 10, the first determining unit 42 further includes:

a second determining module 423, configured to: when a switching manner specified in the switching request is specified switching, and the switching request carries identification information of the second application program, determine, according to the identification information of the second application program, the second application program from the another application program that belongs to the same application program association relationship as the first application program.

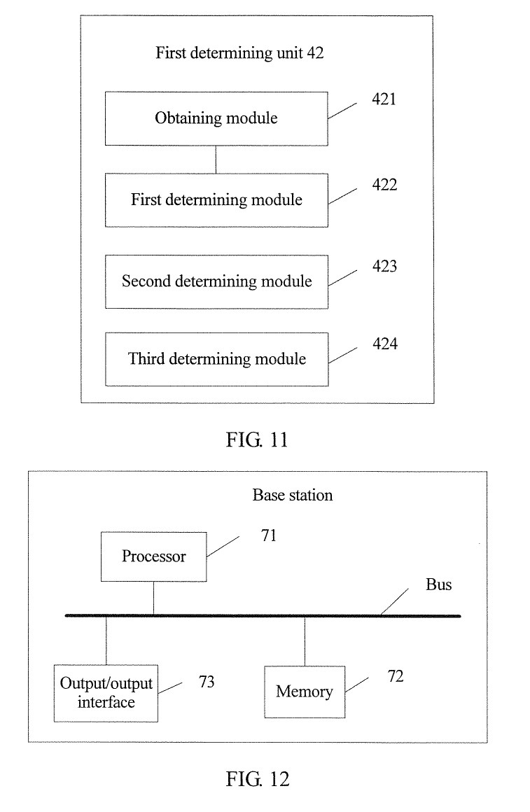

Optionally, as shown in FIG. 11, the first determining unit 42 further includes:

a third determining module 424, configured to: when a switching manner specified in the switching request is specified switching, and the switching request carries association relationship identification information and identification information of the second application program, determine, according to the identification information of the second application program, the second application program from an application program that belongs to an application program association relationship list corresponding to the association relationship identification information.

The application program switching apparatus provided in this embodiment of the present invention responds to a switching request, searches an application program association relationship for a second application program that satisfies a requirement of a user, and directly starts the second application program, so that the user can start the second application program by sending the switching request only once. According to an existing technical solution in the prior art, the user needs to close a currently used program, return to a homepage of an operating system, then search multiple application programs for a new application program, and select the new application program to start. In comparison, according to a technical solution in the present invention, the user only needs to send a switching request, and a terminal automatically completes a remaining procedure, which is faster and more convenient, and brings better experience to the user.

An embodiment of the present invention provides an electronic terminal. As shown in FIG. 12, the electronic terminal includes a processor 71, a memory 72, and an input/output interface 73 that are all configured to implement the method procedure shown in FIG. 1 to FIG. 6. The memory 72 stores an application program. The processor 71 invokes the application program stored in the memory 72, and controls the input/output interface 73.

The input/output interface 73 is configured to obtain a switching request, where the switching request is used to request to switch from a first application program to a second application program.

The processor 71 is configured to determine the second application program from an application program association relationship according to the obtained switching request, and start the determined second application program.

The memory 72 is further configured to store the application program association relationship.

Optionally, before the step of obtaining a switching request is executed, the processor 71 is further configured to: obtain type information of a to-be-added application program; determine, from the existing application program association relationship, an application program association relationship corresponding to the type information; and if there is the application program association relationship corresponding to the type information, add the to-be-added application program to the application program association relationship corresponding to the type information.

The memory 72 is further configured to store an adjusted application program association relationship and a newly established application program association relationship.

Optionally, after executing the step of adding the to-be-added application program to the application program association relationship corresponding to the type information, the processor 71 the processor is further configured to set a switching sequence between an application program in the application program association relationship corresponding to the type information and the to-be-added application program.

Optionally, after executing the step of determining, from the existing application program association relationship, an application program association relationship corresponding to the type information, the processor 71 is further configured to further configured to: if there is no application program association relationship corresponding to the type information, establish a new application program association relationship that includes only the to-be-added application program, and set type information of the new application program association relationship as the type information of the to-be-added application program.

Optionally, before the step of obtaining a switching request is executed, the processor 71 is further configured to: obtain an associated program corresponding to a third application program, where the third application program is an application program that has been added to an application program association relationship; add the associated program to the application program association relationship to which the third application program belongs; and set a switching sequence between the associated program and another application program in an application program association relationship to which the first application program belongs.

The memory 72 is further configured to store an adjusted application program association relationship and a newly established application program association relationship.

Optionally, when executing the step of determining the second application program from an application program association relationship according to the obtained switching request, the processor 71 is further specifically configured to: when a switching manner specified in the switching request is sequential switching, obtain the another application program that belongs to the same application program association relationship as the first application program and a corresponding switching sequence; and determine, according to a switching direction and an offset that are indicated in the switching request and the switching sequence of the another application program that belongs to the same application program association relationship as the first application program, the second application program from the another application program that belongs to the same application program association relationship as the first application program.

Optionally, when executing the step of determining the second application program from an application program association relationship according to the obtained switching request, the processor 71 is further specifically configured to: when a switching manner specified in the switching request is specified switching, and the switching request carries identification information of the second application program, determine, according to the identification information of the second application program, the second application program from the another application program that belongs to the same application program association relationship as the first application program.

Optionally, when executing the step of determining the second application program from an application program association relationship according to the obtained switching request, the processor 71 is further specifically configured to: when a switching manner specified in the switching request is specified switching, and the switching request carries association relationship identification information and identification information of the second application program, determine, according to the identification information of the second application program, the second application program from an application program that belongs to an application program association relationship list corresponding to the association relationship identification information.

The electronic terminal provided in this embodiment of the present invention responds to a switching request, searches an application program association relationship for a second application program that satisfies a requirement of a user, and directly starts the second application program, so that the user can start the second application program by sending the switching request only once. According to an existing technical solution in the prior art, the user needs to close a currently used program, return to a homepage of an operating system, then search multiple application programs for a new application program, and select the new application program to start. In comparison, according to a technical solution in the present invention, the user only needs to send a switching request, and a terminal automatically completes a remaining procedure, which is faster and more convenient, and brings better experience to the user.

Based on the foregoing descriptions of the implementation manners, a person skilled in the art may clearly understand that the present invention may be implemented by software in addition to necessary universal hardware or by hardware only. In most circumstances, the former is a preferred implementation manner. Based on such an understanding, the technical solutions of the present invention essentially or the part contributing to the prior art may be implemented in a form of a software product. The computer software product is stored in a readable storage medium, such as a floppy disk, a hard disk or an optical disc of a computer, and includes some instructions for instructing a computer device (which may be a personal computer, a server, a network device, or the like) to perform the methods described in the embodiments of the present invention.

The foregoing descriptions are merely specific implementation manners of the present invention, but are not intended to limit the protection scope of the present invention. Any variation or replacement readily figured out by a person skilled in the art within the technical scope disclosed in the present invention shall fall within the protection scope of the present invention. Therefore, the protection scope of the present invention shall be subject to the protection scope of the claims.

1. An application program switching method, comprising:
obtaining a switching request, wherein the switching request is used to request to switch from a first application program to a second application program;
determining the second application program from an application program association relationship according to the obtained switching request; and
starting the second application program.

2. The method according to claim 1, wherein before obtaining the switching request, the method further comprises:
obtaining type information of a to-be-added application program;
determining, from an existing application program association relationship, whether there is an application program association relationship corresponding to the type information; and
when there is the application program association relationship corresponding to the type information, adding the to-be-added application program to the application program association relationship corresponding to the type information.

3. The method according to claim 2, after adding the to-be-added application program to the application program association relationship corresponding to the type information, the method further comprises:
setting a switching sequence between an application program in the application program association relationship corresponding to the type information and the to-be-added application program.

4. The method according to claim 2, further comprising:
when there is no application program association relationship corresponding to the type information, establishing a new application program association relationship that comprises only the to-be-added application program, and setting type information of the new application program association relationship as the type information of the to-be-added application program.

5. The method according to claim 4, wherein before obtaining the switching request, the method further comprises:
obtaining an associated program corresponding to a third application program, wherein the third application program is an application program that has been added to an application program association relationship; and
adding the associated program to the application program association relationship to which the third application program belongs, and setting a switching sequence between the associated program and another application program in an application program association relationship to which the first application program belongs.

6. The method according to claim 5, wherein when a switching manner specified in the switching request is sequential switching, determining the second application program from an application program association relationship according to the obtained switching request comprises:
obtaining at least one other application program that belongs to the same application program association relationship as the first application program and a corresponding switching sequence; and
determining, according to a switching direction and an offset that are indicated in the switching request and the switching sequence of the at least one other application program that belongs to the same application program association relationship as the first application program, the second application program from the at least one other application program that belongs to the same application program association relationship as the first application program.

7. The method according to claim 5, wherein when a switching manner specified in the switching request is specified switching, and the switching request carries identification information of the second application program, determining the second application program from an application program association relationship according to the obtained switching request comprises:
determining, according to the identification information of the second application program, the second application program from the another application program that belongs to the same application program association relationship as the first application program.

8. The method according to claim 5, wherein when a switching manner specified in the switching request is specified switching, and the switching request carries association relationship identification information and identification information of the second application program, determining the second application program from an application program association relationship according to the obtained switching request comprises:
determining, according to the identification information of the second application program, the second application program from an application program that belongs to an application program association relationship list corresponding to the association relationship identification information.

9-16. (canceled)

17. An electronic device, comprising:
a processor;
a memory;
an input/output interface;
wherein the memory stores an application program, and the processor invokes the application program stored in the memory for controlling the input/output interface;
the input/output interface is configured to obtain a switching request, wherein the switching request is used to request to switch from a first application program to a second application program;
the processor is configured to:
determine the second application program from an application program association relationship according to the obtained switching request, and start the second application program; and
the memory is further configured to store the application program association relationship.

18. The electronic device according to claim 17, wherein obtaining the switching request, the processor is further configured to:
obtain type information of a to-be-added application program;
determine, from an existing application program association relationship, whether there is an application program association relationship corresponding to the type information; and
when there is the application program association relationship corresponding to the type information, add the to-be-added application program to the application program association relationship corresponding to the type information.

19. The electronic device according to claim 17, wherein the processor is further configured to:
after adding the to-be-added application program to the application program association relationship corresponding to the type information, set a switching sequence between an application program in the application program association relationship corresponding to the type information and the to-be-added application program.

20. The electronic device according to claim 18, wherein the processor is further configured to:
when there is no application program association relationship corresponding to the type information, establish a new application program association relationship that comprises only the to-be-added application program, and set type information of the new application program association relationship as the type information of the to-be-added application program.

21. The electronic device according to claim 20, wherein before obtaining the switching request, the processor is further configured to:
obtain an associated program corresponding to a third application program, wherein the third application program is an application program that has been added to an application program association relationship;
add the associated program to the application program association relationship to which the third application program belongs; and
set a switching sequence between the associated program and another application program in an application program association relationship to which the first application program belongs.

22. The electronic device according to claim 21, wherein when determining the second application program from an application program association relationship according to the obtained switching request, the processor is configured to:
when a switching manner specified in the switching request is sequential switching, obtain at least one other application program that belongs to the same application program association relationship as the first application program and a corresponding switching sequence; and
determine, according to a switching direction and an offset that are indicated in the switching request and the switching sequence of the at least one other application program that belongs to the same application program association relationship as the first application program, the second application program from the at least one other application program that belongs to the same application program association relationship as the first application program.

23. The electronic device according to claim 21, wherein when of determining the second application program from an application program association relationship according to the obtained switching request, the processor is configured to:
when a switching manner specified in the switching request is specified switching, and the switching request carries identification information of the second application program, determine, according to the identification information of the second application program, the second application program from the another application program that belongs to the same application program association relationship as the first application program.

24. The electronic device according to claim 21, wherein when determining the second application program from an application program association relationship according to the obtained switching request, the processor is configured to:
when a switching manner specified in the switching request is specified switching, and the switching request carries association relationship identification information and identification information of the second application program, determine, according to the identification information of the second application program, the second application program from an application program that belongs to an application program association relationship list corresponding to the association relationship identification information.

25. The method according to claim 3, further comprising:
when there is no application program association relationship corresponding to the type information, establishing a new application program association relationship that comprises only the to-be-added application program, and setting type information of the new application program association relationship as the type information of the to-be-added application program.

26. The electronic device according to claim 19, wherein the processor is further configured to:
after adding the to-be-added application program to the application program association relationship corresponding to the type information, set a switching sequence between an application program in the application program association relationship corresponding to the type information and the to-be-added application program.
